(19) United States
(12) Patent Application Publication
(10) Pub. No.: US 2022/0076328 A1
(43) Pub. Date: Mar. 10, 2022

(54) SOCIAL NETWORK AND FINANCIAL APPLICATION

(71) Applicant: Kandaria Rolle Napier, (US)

(72) Inventor: Kandaria Rolle Napier, (US)

(21) Appl. No.: 16/458,192

(22) Filed: Jul. 1, 2019

(51) Int. Cl. G06Q 40/02; G06Q 50/00

(52) U.S. Cl. CPC G06Q 40/025; G06Q 50/01

(57) ABSTRACT

Implementations of a social network and financial application are provided. In some implementations, the social network and financial application relates to technology for financial services (fintech). In some implementations, the social network and financial application provides a social and digital lending platform that connects consumers, banks, and lenders to make the lending process (and other financial services) easier. In some implementations, the social network and financial application provides a content management system, messaging system, tracking system, planning system, risk analytics system, and/or a fraud deterrent system.

This disclosure relates to implementations of social network and financial application.

### BRIEF DESCRIPTION OF THE DRAWINGS

FIGS. 1, 3, 4A-C, and 5 illustrate implementations of example social and financial services environments according to the present disclosure.

FIG. 2 illustrates an example computer system, which may be used with implementations of the present disclosure.

### DETAILED DESCRIPTION

The present disclosure relates to technology for financial services (fintech). More specifically, the present disclosure is a social and digital lending platform that connects consumers, banks, and lenders to make the lending process (and other financial services) easier. In some implementations, the social and digital lending platform of the present disclosure is a content management system, messaging system, tracking system, planning system, and/or risk analytics system. In some implementations, the social and digital lending platform of the present disclosure is a fraud deterrent system. The social and digital lending platform of the present disclosure has many other financial and non-financial uses discuss below.

In some implementations, the social and digital lending platform of the present disclosure is configured to track the progress of a loan engagement from beginning to end and is viewable by the stakeholders. Other business or actions may be tracked such as payments made, money saved, etc.

In some implementations, the social and digital lending platform of the present disclosure is configured to market different financial services to consumers, banks, lenders and all other partners in the financial services industry as well as partners in the financial wellness business.

In some implementations, the social and digital lending platform of the present disclosure is configured as a planning and risk analytics system such that a user can have access to a budget for financial planning. In some implementations, the social and digital lending platform of the present disclosure is configured to use analytics to display the user's financial picture. For example, the social and digital lending platform of the present disclosure may be configured to compute and display how much a user's income is currently spent on the user's debt and how much income is being saved.

In some implementations, the social and digital lending platform of the present disclosure is configured to reduce fraud because a user's identification and personal credentials are verified early and upfront as well as throughout an engagement. This type of identification mechanism reduces, deters and may eliminate fraud within an engagement all together.

In some implementations, the social and digital lending platform of the present disclosure is configured to send encrypted data sets. For example, in some implementations, the social and digital lending platform of the present disclosure is configured to use encrypted or otherwise secure or private data sets with blockchain capabilities and/or other suitable coding.

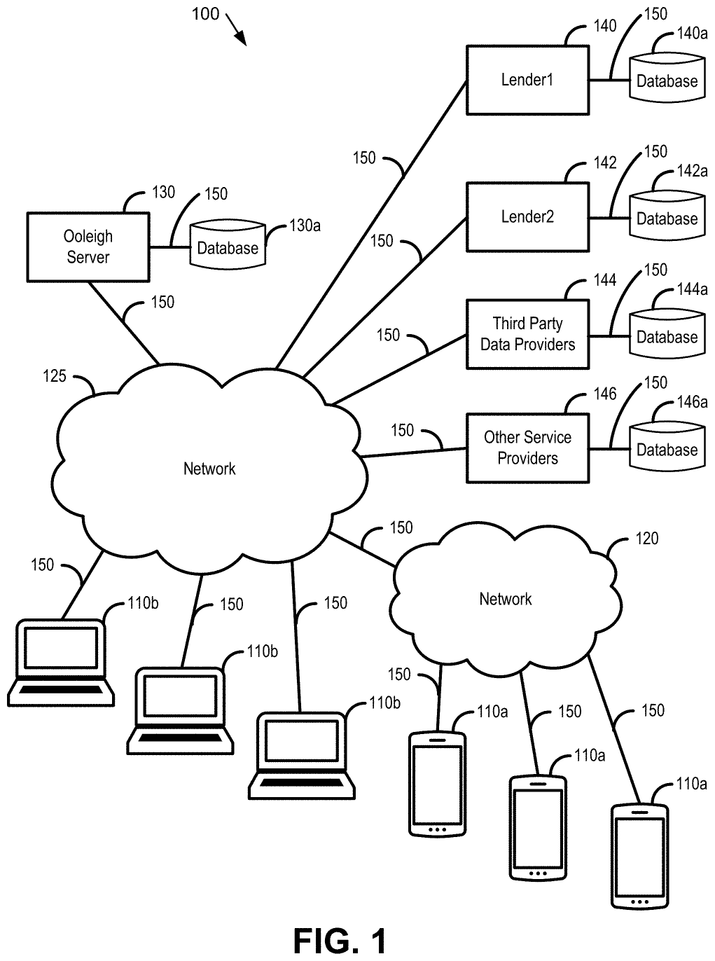

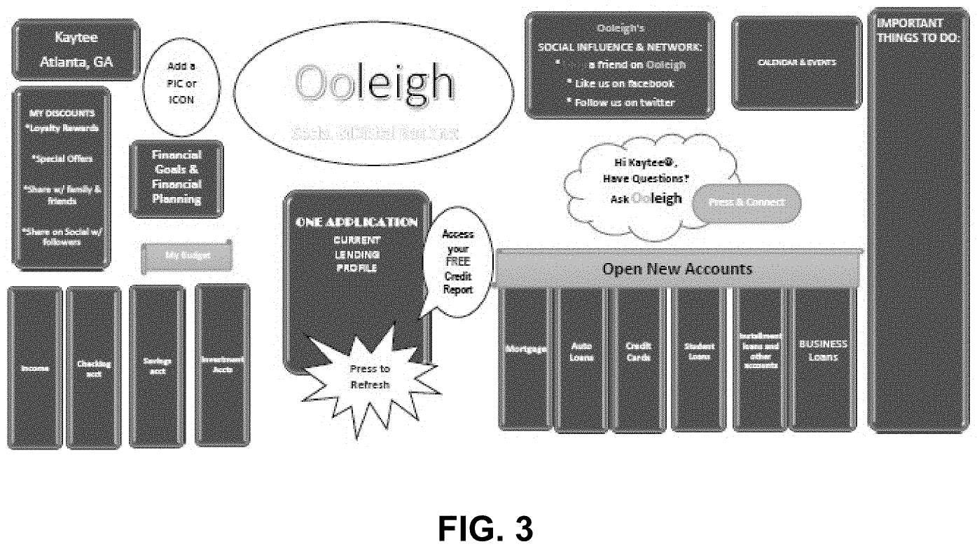

FIGS. 1, 3, and 5 illustrate implementations of example social and financial services environments of the present disclosure.

The social and digital lending platform is configured to allow a consumer to create a financial profile that is stored and can be used for future needs (e.g., requests for credit, risk analysis, processing or closing credit instruments, budgeting, etc.). For example, the profile can be used for different requests for credit from different vendors. In this way, the consumer does not need to use different platforms from different financial services or vendors. The consumer's financial profile is in one repository that can be accessed (with an invitation similar to a social network connection request) by different vendors (banks, lenders, etc.) or used for different financial services or purposes (e.g., risk assessment, budgeting, etc.). In this way, consumers can manage their financial matters better within one easy to use, time-saving platform.

In some implementations, a consumer's financial profile comprises: personal data relating to financial service requests, credit report, credit score, liabilities, employment data, asset data, etc. In some implementations, a consumer's financial profile comprises documents and other related materials such as Photo ID such as a driver license, passport, citizenship documents, income documents, assets documents, credit documents, real estate owned documents, or legal documents such as will, birth certificate, marriage license, or trust agreement. In some implementations, a consumer's financial profile comprises social security number, names, date of birth, bank account numbers, loan applications for requests for credit, income tax returns, paystubs, W2's, etc.

In some implementations, this user profile has a born-on date as well as a content expiration date where on the content expiration dates content may self-purge. In some implementations, the platform is configured to automatically refresh/update the consumer's profile data. As discussed above, this data can be used by different vendors or for different financial services or purposes. In some implementations, data can be refreshed by pulling a new credit report once an older credit report expires or becomes aged due to changes in a user's credit history. A profile owner may pull his/her own credit to refresh it, or, an authorized partner may pull new credit and refresh credit data.

As discussed above, the social and digital lending platform of the present disclosure is configured to allow the consumer to connect to the social and digital lending platform or with a vendor (e.g., a lender) through a social network (e.g., via messaging or invitation or other social network or network type manner). The consumer may connect with the social and digital lending platform to create a profile or with a vendor to apply for credit or other products. The consumer may invite the vendor to the social and digital lending platform or a vendor may invite the consumer to engage in such a consideration.

Once connected, the vendor can utilize the consumer's financial profile to help simplify the lending process because much of the data that the lender will need will already be available in the consumer's financial profile. For example, the social and digital lending platform is configured to self-populate data into specific forms relating to a transaction. For example, if a user selects an auto loan application, the user name, current date, current address, current income, current employer and social security number can self-populate into the auto loan application.

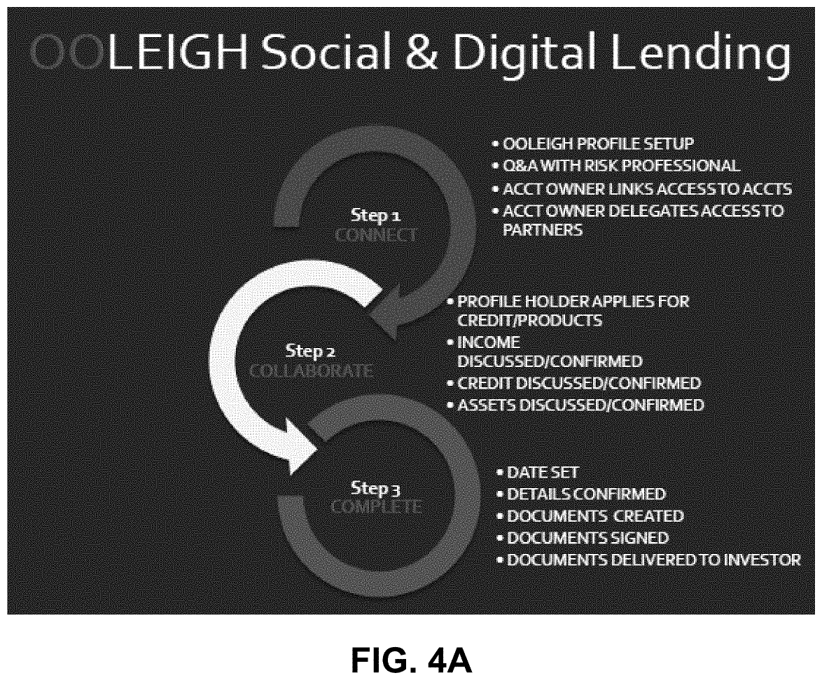

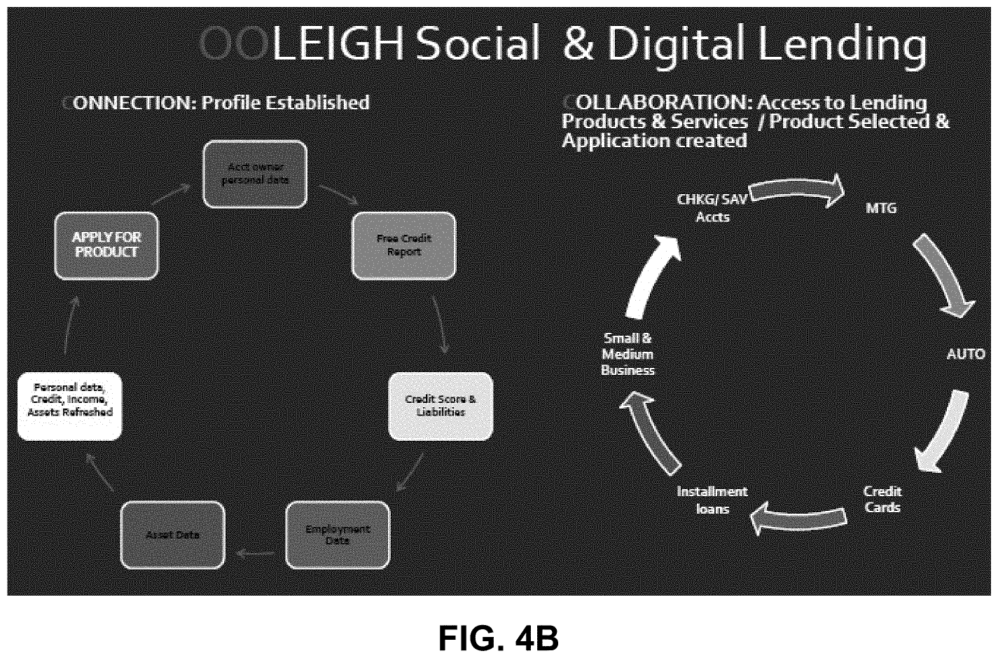

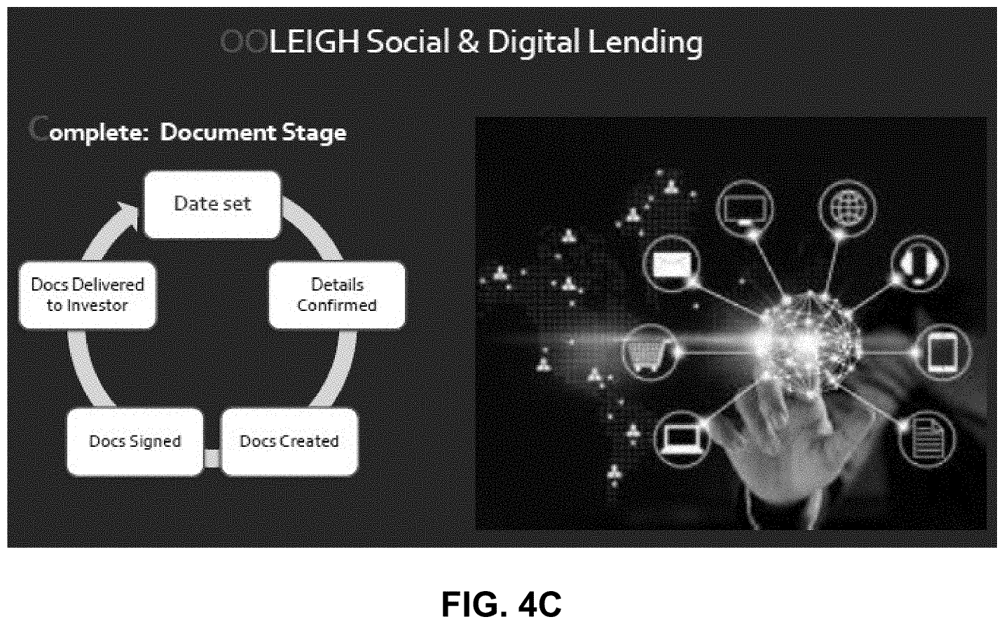

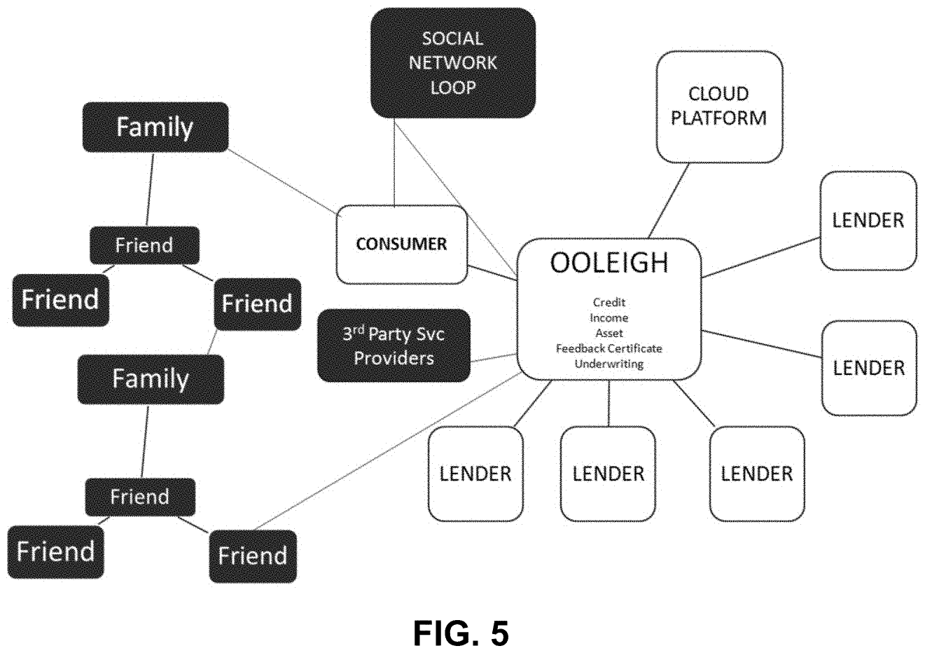

FIGS. 4A-C illustrate implementations of example methods of the social and digital lending platform of the present disclosure to simplify the lending process.

In some implementations, the social and digital lending platform of the present disclosure may be configured to provide applicable lending application forms specific to a direct request for funding. In some implementations, the social and digital lending platform of the present disclosure may be configured to request and received information for a user to create a request for credit to be submitted as an online application.

In some implementations, the social and digital lending platform of the present disclosure may be configured to calculate lending requirements (e.g., documentation and risk requirements), documents, and standards relating to the user profile based on a set of automated queries. For example, if a user indicates that he/she is self-employed, the social and digital lending platform of the present disclosure may be configured to itemize a list of required income documents to prepare for a request for credit.

In some implementations, the social and digital lending platform of the present disclosure may be configured to provide feedback specific to individual circumstances relating to the lending process and requirements. For example, the social and digital lending platform may provide a borrower with a list of documents required to apply for a loan program/product. The social and digital lending platform may provide a borrower with the average credit score for a product. The social and digital lending platform may provide a borrower with his/her percentage of debt to income and the credit guidelines for a potential approval for a specific product/program. The social and digital lending platform may provide credit score feedback and guidance, etc. relating to borrower credit profile.

Consumer may also connect with other consumers in a social network-type manner to, for example, to offer feedback, share user experience, share knowledge of financial services or financial wellness tools, etc., or to recommend a product or service to current and potential users. The social and digital lending platform of the present disclosure can be used as a platform to market and advertise banks, lending partners and other related or complimentary businesses and services, to share financial and wellness products/services specifics to user base, to promote financial wellness and financial inclusion, and to create a new and open forum for a transparent credit conversation and wealth management and financial planning platform, and for messaging generally. In some implementations, the social and digital lending platform may be configured to send messages/email to communicate with internal/external partners to a transaction or engagement, for users to post/share content on other social networks, to share general content, or engage in conversations on matters related to financial services and financial wellness.

In some implementations, the social and digital lending platform of the present disclosure allows users to connect in a social network manner, for example, as shown in FIG. 5.

The social and digital lending platform of the present disclosure may also be configured as a source for financial news, articles, blogs and publications as well as video streaming and online tutorials.

The social and digital lending platform of the present disclosure may also be used by data collaborators to, for example, determine unbanked or underbanked consumers, determine user demographics and provide the best products and services, and to target and serve specific groups.

The social and digital lending platform of the present disclosure may also be a tracking platform. In some implementations, the social and digital lending platform may be configured to track the progress of a service or product request from beginning to completion such as a loan application. In some implementations, the social and digital lending platform may be configured to track the demographics of users, such as user location and user partners within an engagement. In some implementations, the social and digital lending platform may be configured to help profile holders track their spending patterns, loan balances, interest rates, link accounts, make payments and manage their household budgets as well as store family documents such as a copy of Will/Birth Certificate/Marriage License etc. In some implementations, the social and digital lending platform may be configured to be a marketplace for purchasing of different materials such as financial planners/organizers, self-help products/books, and anything related to financial wellness, financial planning, budgeting and money management and personal financial growth. In some implementations, the social and digital lending platform may be configured to provide notifications that will originate from the messaging/email platform, which also can be tracked with send/receive receipts as part of notifying partners and confirming communication. For example, a progress timeline viewable to authorized parties to the engagement may be implemented to keep engagements on schedule, set clear expectations and outcomes. As another example, the tracking system may be used to notify stakeholders of potential concerns or obstacles impacting process. The tracking system is meant to provide transparent sharing or details and information with authorized parties to an engagement.

The social and digital lending platform of the present disclosure may be a predictive channel of automated digital feedback responses provided to the user based on a certain set of circumstances, specific to the request. For example, in some implementations, the social and digital lending platform of the present disclosure may be configured to determine a user's last home purchase date based on their general profile content such as time at current residential address and their credit report. The social and digital lending platform of the present disclosure may be configured to use this data for marketing to this user regarding new homes.

The social and digital lending platform of the present disclosure is configured to change the engagement of consumers, lenders and banking partners and all other stakeholders within the experience and simplify lending and financial services needs through a high degree of transparency and inclusion. Transparency within the platform means a user, in some implementations, will have access to the entire lending experience and can communicate with all stakeholders within the engagement. Presently, borrowers do not have this access and communication can be limited to a borrower. For example, currently borrowers are not allowed to speak directly to a credit underwriter or risk manager within their lending engagement. In some implementations, the social and digital lending platform of the present disclosure is configured such that a user may speak/communicate with a credit underwriter/risk manager.

Returning to FIG. 1, in some implementations, the social and financial services environment 100 may comprise one or more client devices 110a and 110b (collectively client device 110), a wireless cellular network 120, a network 125, a social and digital lending (OOLEIGH) server 130 and associated database 130a, and one or more third party client or servers e.g., lenders 140, 142, and third party data providers 144, other service providers 146. In some implementations, the example environment 100 also may include one or more data storage 130a1 linked to the social and digital lending server 130. In some implementations, the example environment 100 may include a social network, for example, as shown in FIG. 5.

As discussed above, in some implementations, a client device 110 (or devices 130, 140, 142, 144, 146) may be used by users (or server 130 or third parties) of the social and digital lending server 130 to connect consumers, banks, and lenders to make the lending process (and other financial services) easier.

As discussed above, in some implementations, the client device 110 may be used to allow a consumer to create a financial profile that is stored (e.g., in database 130a1) and can be used for future needs. As discussed above, in some implementations, the platform is configured to automatically refresh/update the consumer's profile data. As discussed above, this data can come from or be used by different vendors (e.g., lenders 140, 142, and third party data providers 144, other service providers 146) or for different financial services or purposes.

As discussed above, the social and digital lending server 130 of the present disclosure is configured to allow the consumer 110 to connect with a vendor (e.g., lenders 140, 142, and third party data providers 144, other service providers 146) through a social network (e.g., via messaging or invitation).

As discussed above the social and financial services environment 100 of the present disclosure may also be configured as a source for financial news, articles, blogs and publications as well as video streaming and online tutorials. The social and financial services environment 100 has many other functions as discussed above.

Client devices 110a and 110b are depicted as a mobile phone 110a and desktop computer 110b, respectively, but client devices 110 (or devices 130, 140, 142, 144, 146) may comprise any type of computing device. For example, client device 110 may comprise any type of computing device, such as a desktop computer system, a laptop, cellular phone, a smart device, a mobile telephone, a tablet-style computer, or any other device capable of wireless or wired communication. In some implementations, client device 110 is configured to interact with the social and digital lending server 130 via an application, such as a web browser or a native application, residing on the client device 110.

In some implementations, the client devices 110 includes hardware, software, or embedded logic components or a combination of two or more such components and is configured to carry out the appropriate functions implemented or supported by the client devices 110.

In some implementations, the client devices 110 (or devices 130, 140, 142, 144, 146) may include one or more processors, one or more memories, one or more displays, one or more interfaces, one or more components capable of inputting data, one or more components capable of outputting data, one or more components capable of communicating with any other component of the environment 100, or any other component suitable for a particular purpose.

In some implementations, the client devices 110 are configured to access networks 120 and/or 125. In some implementations, the client devices 110 are configured to communicate with servers 130, 140, 142, 144, 146.

In some implementations, the client device 110 can connect to the network 125 through a wireless cellular network 120, such as GPRS-based and CDMA-based wireless networks, as well as 802.16 WiMax and long-range wireless data networks.

In some implementations, components of the social and financial services environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the social and financial services environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may not be the same throughout the environment 100.

In some implementations, the server devices 130, 140, 142, 144, 146 may include a processor, memory, user accounts, and one or more modules to perform various functions such as those described above.

In some implementations, each server 130, 140, 142, 144, 146 may be a unitary server or may be a distributed server spanning multiple computers or multiple datacenters. Servers 130, 140, 142, 144, 146 may be of various types, such as, for example and without limitation, web server, file server, application server, exchange server, database server, or proxy server. In some implementations, each server 130, 140, 142, 144, 146 may include hardware, software, or embedded logic components or a combination of two or more such components for carrying out the appropriate functionalities implemented or supported by server 130, 140, 142, 144, 146. For example, a web server is generally capable of hosting websites containing web pages or particular elements of web pages. More specifically, a web server may host HTML files or other file types, or may dynamically create or constitute files upon a request, and communicate them to clients 110 (or 130, 140, 142, 144, 146) in response to HTTP, HTTPs, or other requests from clients 110 (or 130, 140, 142, 144, 146). A database server is generally capable of providing an interface for managing data stored in one or more data stores.

In some implementations, one or more data storages (e.g., 130a) may be communicatively linked to one or more servers (e.g., 130), respectively, via one or more links 150. In some implementations, data storages may be used to store various types of information, such as a consumer's financial profile such as personal data relating to financial service requests, credit report, credit score, liabilities, employment data, asset data, etc. In some implementations, the information stored in data storages may be organized according to specific data structures. In particular embodiment, each data storage may be a relational database. Particular embodiments may provide interfaces that enable servers (e.g., 130, 140, 142, 144, 146) or clients (110, 130, 140, 142, 144, 146) to manage, e.g., retrieve, modify, add, or delete, the information stored in data storage.

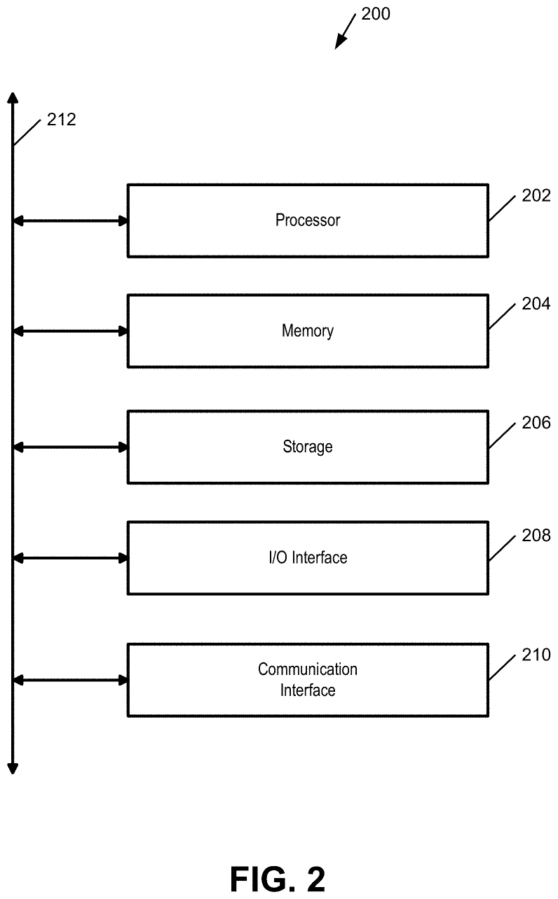

FIG. 2 illustrates an example computer system 200, which may be used with some implementations of the present invention. This disclosure contemplates any suitable number of computer systems 200.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website.

Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

The figures, including photographs and drawings, comprised herewith may represent one or more implementations of the social network and financial application.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings. Attached hereto are additional implementations of a social network and financial application.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A computer-implemented method for providing a social and digital lending platform, the method comprising:
receiving by a first system over a network financial profile information related to a first customer from a first computing device and storing the financial profile information associated with the first customer;
receiving by the first system over a network a plurality of invitations associated with a plurality of vendors respectively to use the stored financial profile information associated with the first customer and upon receiving an acceptance of an invitation over a network, transmitting the financial profile information associated with the first customer over a network to a vendor computing device associated with the acceptance;
receiving by the first system over a network financial profile information related to a second customer from a second computing device and storing the financial profile information associated with the second customer; and
receiving by the first system over a network an invitation to transmit information between the first computing device and the second computing device and upon receiving an acceptance of the invitation transmitting information between the first computing device and the second computing device.

2. The computer-implemented method of claim 1 wherein at least one of the invitations to use the stored financial profile information associated with the first customer is from a lender at the vendor computing device and the acceptance of the at least one invitation is from the first customer at the first computing device.

3. The computer-implemented method of claim 1 wherein at least one of the invitations to use the stored financial profile information associated with the first customer is from the first customer at the first computing device and directed to a lender at the vendor computing device and the acceptance of the at least one invitation of the invitations is from. the vendor computing device.

4. The computer-implemented method of claim 1 wherein the invitation to transmit information between the first computing device and the second computing device is from the first customer at the first computing device and the acceptance of the invitation is from the second customer at the second computing device.

5. The computer-implemented method of claim 1 wherein the invitation to transmit information between the first computing device and the second computing device is from the second customer at the second computing device and the acceptance of the invitation is from the first customer at the first computing device.

6. The computer-implemented method of claim 1 wherein the financial profile information comprises a name, address, income, employer information, and social security number.

7. The computer-implemented method of claim 1 further comprising populating lending forms using the stored financial profile information.

8. The computer-implemented method of claim 1 further comprising determining based on the financial profile information received additional documentation for lending requirements.

9. The computer-implemented method of claim 1 further comprising automatically updating the financial profile information.

10. A computer-implemented method for providing a social and digital lending platform, the method comprising:
receiving by a first system over a network financial profile information related to a first customer from a first computing device and storing the financial profile information associated with the first customer;
receiving by the first system over a network a plurality of invitations associated with a plurality of vendors respectively to use the stored financial profile information associated with the first customer and upon receiving an acceptance of an invitation over a network, transmitting the financial profile information associated with the first customer over a network to a vendor computing device associated with the acceptance;
receiving by the first system over a network financial profile information related to a second customer from a second computing device and storing the financial profile information associated with the second customer;
receiving by the first system over a network an invitation to transmit information between the first computing device and the second computing device and upon receiving an acceptance of the invitation transmitting information between the first computing device and the second computing device;
populating lending forms using the stored financial profile information;
determining based on the financial profile information received additional documentation for lending requirements; and
automatically updating the financial profile information.

11. A social and digital lending platform comprising:
a computing device having stored thereon financial profile information associated with a plurality customers respectively; and
a non-transitory computer readable medium containing instructions that, when executed by a processor on the computing device, cause the computing device to:
transmit the financial profile information associated with a first customer of the plurality customers over a network to a vendor computing device upon receiving by the computing device over a network an invitation to use the stored financial profile information associated with the first customer and receiving an acceptance of the invitation; and
transmit information between a first computing device associated with the first customer and a second computing device associated with a second customer of the plurality customers upon receiving by the computer system over a network an invitation to transmit information between the first computing device and the second computing device and upon receiving an acceptance of the invitation.

12. The social and digital lending platform of claim 11 wherein the non-transitory computer readable medium further contains instructions that, when executed by a processor on the computing device, cause the computing device to populate lending forms using the stored financial profile information.

13. The social and digital lending platform of claim 11 wherein the non-transitory computer readable medium further contains instructions that, when executed by a processor on the computing device, cause the computing device to determine based on the financial profile information received additional documentation for lending requirements.

14. The social and digital lending platform of claim 11 wherein the non-transitory computer readable medium further contains instructions that, when executed by a processor on the computing device, cause the computing device to automatically update the financial profile information.
